(19) United States
(12) Patent Application Publication
(10) Pub. No.: US 2010/0090949 A1
(43) Pub. Date: Apr. 15, 2010

(54) Method and Apparatus for Input Device

(75) Inventors: Chen Tianqiao, Shanghai (CN); An Liqun, Shanghai (CN); Yan Zhenghua, Shanghai (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Shanda Computer (Shanghai) Co., Ltd., Central Hong Kong (CN)

(21) Appl. No.: 12/501,360

(22) Filed: Jul. 10, 2009

Related U.S. Application Data
(60) Provisional application No. 61/082,729, filed on Jul. 22, 2008.

(51) Int. Cl. G06F 3/033

(52) U.S. Cl. 345/158

(57) ABSTRACT

Method and apparatus for an input device. In an embodiment, the present invention provides an apparatus that is designed as a hollow-out glove, which can be worn on the wrist of a user. This apparatus has three working mode: touch mode, air-mouse mode, and action-induction mode. In touch mode, it works with laser-positioning device to identify the user's moving motion; in air-mouse mode, it works with multi-sensors to capture user's moving motion; in action-induction mode, the apparatus can track all the directions of user's moving motion. This invention also provides a method to operate this apparatus. It makes it possible to position accurately in the space and capture the user's moving motion.

### CROSS-REFERENCE TO RELATED APPLICATIONS

The present application claims priority to U.S. Provisional Application No. 61/082,729, filed Jul. 22, 2008, which is incorporated by reference herein for all purposes.

### BACKGROUND OF THE INVENTION

The present invention is directed to a system and method for user interface device. More specifically, user interface devices adapted to be attached to users' hands that can be used to capture various types of motions are provided. In a specific embodiment, the present invention provides a user input device that is attachable to one or more human hands. The user input device includes a laser module for capturing motion information against a surface and an accelerometer module for capturing spatial motional information. There are other embodiments as well.

Since the invention of the first computing device, scientists and engineers have been worked hard to improve the user interface and techniques for communicating with computing devices. In the early days, the computer scientists used punch cards to communicate input data that can be understood by the early computer. With the advent of computing devices, more convenient user interface have been developed. Keyboard, mouse, and joystick are all common user interface devices that help end users to communicate with computing devices. Keyboards are optimized for facilitating text input. Mouse device are primarily used for making user selections. Joysticks are mostly used for gaming activities.

Keyboard, mouse, and joysticks have been used for many years, and they remain popular and ubiquitous. However, these “common” devices are not enough for many specific applications. For instance, tablet types of devices are preferred in CAD and image processing works. Similarly, gaming controllers with limited motion sensing capability have also been invented and implemented in the new generation of gaming systems.

Unfortunately, the conventional input devices are inadequate for many reasons, which are explained below. And new input devices are desired.

### BRIEF SUMMARY OF THE INVENTION

The present invention is directed to a system and method for user interface device. More specifically, user interface devices adapted to be attached to users' hands that can be used to capture various types of motions are provided. In a specific embodiment, the present invention provides a user input device that is attachable to one or more human hands. The user input device includes a laser module for capturing motion information against a surface and an accelerometer module for capturing spatial motional information. There are other embodiments as well.

In an embodiment, the present invention provides an apparatus that is designed as a hollow-out glove, which can be worn on the wrist of a user. This apparatus has three working mode: touch mode, air-mouse mode, and action-induction mode. In touch mode, it works with laser-positioning device to identify the user's moving motion; in air-mouse mode, it works with multi-sensors to capture user's moving motion; in action-induction mode, the apparatus can track all the directions of user's moving motion. This invention also provides a method to operate this apparatus. It makes it possible to position accurately in the space and capture the user's moving motion.

According to an embodiment of the present invention, the present invention provides an user interface device. The device includes a housing member, the housing member including a first portion, the first portion being conforming to human hand. The device also includes a battery, the battery being positioned inside the housing member. Furthermore, the device includes a control module, the control module being electrically coupled to the battery, the control module being configured to select input modes. The device also includes a laser pointing module, the laser point module being adapted for attaching to one or more of fingers, the laser pointing module being configured to capture finger movements from the one or more fingers in relation to a surface. Additionally, the device includes an accelerometer module being adapted to be attached a user hand, the accelerometer module being configured to capture the hand movement. The device also includes one or more keys being adapted to receive user input. The device further includes a wireless transmitter. The control module is configured to determine an input mode, process finger movements and/or hand movements based at least on input mode, generate one or more signals based on the finger movements and/or hand movements, and transmit the one or more signals.

According to another embodiment, the present invention provides a user interface device, which includes a battery module configured to provide power. The device also includes a connection housing adapted for attaching the device to a user's hands with wires. The device further includes a switch key configured to determine an operation mode, operation mode being selected from a touch mode, an air-mouse mode, and an action-induction mode. Moreover, the device includes a laser-positioning device being attachable to one or more fingers, the laser positioning device being configured to capture motion information relative to a surface in the touch mode. The device includes one or more accelerometer devices for capturing motion information in the air-mouse mode and the action-induction mode. The device also includes a control module being configured for processing the captured motion information. Also, the device includes a transmitter for sending processed motion information. The device further includes a touch point for receiving user inputs, the touch point being adaptable for functioning as a left mouse key. Additionally, the device includes one or more control keys for receiver user inputs, the one or more control keys being configured to function as programmable mouse keys.

According to yet another embodiment, the present invention provides a method for operating a user interface device. The method includes providing the user interface device, the user interface device comprising a laser point module, an accelerometer module, a wireless transmitter, and a mode selection module. The method also includes determining an input mode based on a status indicated by the mode selection module. If the input mode is in a mouse mode, the method includes capturing movement information using the laser pointing module, processing the captured movement information, and transmitting the processed movement information using the wireless transmitter. If the input mode is in a free mode, the method includes capturing movement information using the accelerometer module, processing the captured movement information, and transmitting the processed movement information using the wireless transmitter.

It is to be appreciated that embodiments of the present invention offer numerous advantages over conventional devices. Among other features, the user interface devices according to the embodiments of the present invention provide integrated accelerometer and pointing modules for motion capturing, and a user is able to use the same input device to perform a variety of functions. In a specific embodiment, the present invention also includes a security module that enables a user that “wears” an input device to automatically log onto the system using a predetermined scheme. Depending upon the embodiment, one or more of these benefits may be achieved. These and other benefits and various additional objects, features and advantages of the present invention can be more fully appreciated with reference to the detailed description and accompanying drawings that follow.

### BRIEF DESCRIPTION OF THE DRAWINGS

FIG. 1 is a simplified diagram illustrating a user input device. This diagram is merely an example, which should not unduly limit the scope of the claims.

FIG. 2 is a simplified diagram providing an alternative view of the input device 100.

FIG. 3 is a simplified block diagram illustrating component modules of a input device according to an embodiment of the present invention.

FIG. 4 is a simplified flow diagram illustrating a method for using an input device according to an embodiment of the present invention.

### DETAILED DESCRIPTION OF THE INVENTION

The present invention is directed to a system and method for user interface device. More specifically, user interface devices adapted to be attached to users' hands that can be used to capture various types of motions are provided. In a specific embodiment, the present invention provides a user input device that is attachable to one or more human hands. The user input device includes a laser module for capturing motion information against a surface and an accelerometer module for capturing spatial motional information. There are other embodiments as well.

As explained above, conventional input devices are often inadequate. In the computer technology field, a mouse or a keyboard is generally considered as computer inputting device, which can be moved freely on a flat surface. Operating the mouse device, we can control the program run in the computer or other terminals. Typically, a conventional mouse or a keyboard devices requires a fixed flat surface, user has to sit beside or stand by the side of the flat surface, so he can operate the mouse device easily. For example, when a user want to input words, he has to rely on a device such as a keyboard or a writing pad, which are also rely on a fixed flat surface.

The functionality and use of keyboards and mice are both specific and limited. They are not suitable, for instance, for gaming and other endeavors that would require more user interaction with computing devices. As mentioned above, joysticks have been invented specifically for playing games. In the new generation of gaming systems, such as NINTENDO Wii 3, game controllers now have limited motion capturing capability. For instance, Wii game controller would capture a player's movement by determining the relative movement and position of a game controller to a receiving device that is located near the display (e.g., television).

Unfortunately, as useful as the new generation of input devices are, they are still limited. Among other things, the motion capturing from Wii controllers is not accurate enough for many applications, and they are difficult to use for text input and other functions. Therefore, it is to be appreciated that embodiments of the present invention provide novel user input devices, which are described in detail below.

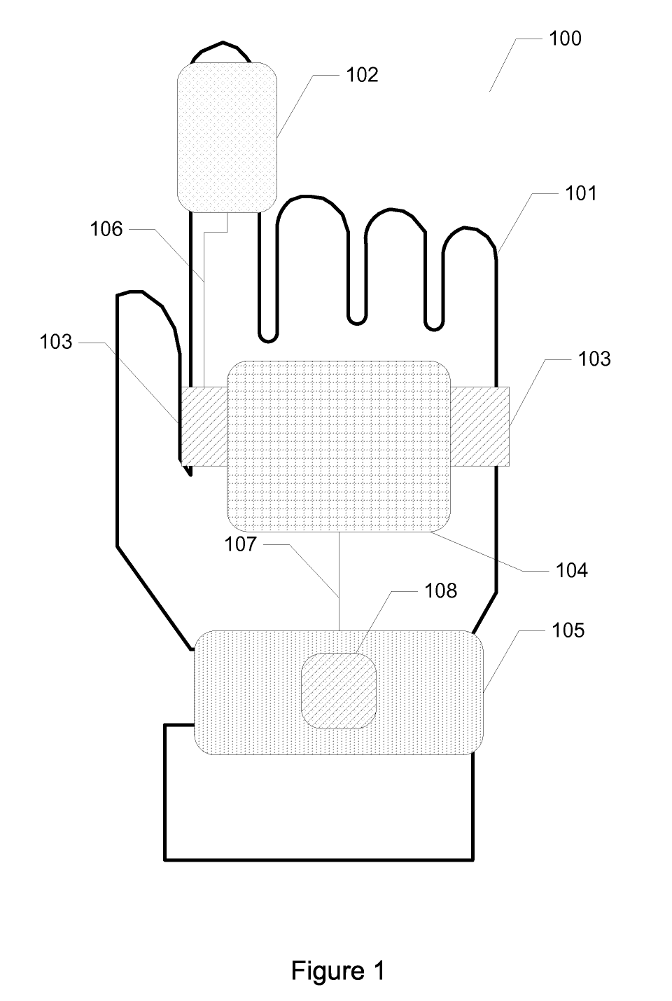

FIG. 1 is a simplified diagram illustrating a user input device. This diagram is merely an example, which should not unduly limit the scope of the claims. One of ordinary skill in the art would recognize many variations, alternatives, and modifications. As shown in FIG. 1, an input device 100 includes the following components:

1. a pointing module 102;

2. a motion sensing module 104;

3. hand strap 103;

4. a wrist component 105; and

5. a user button 108.

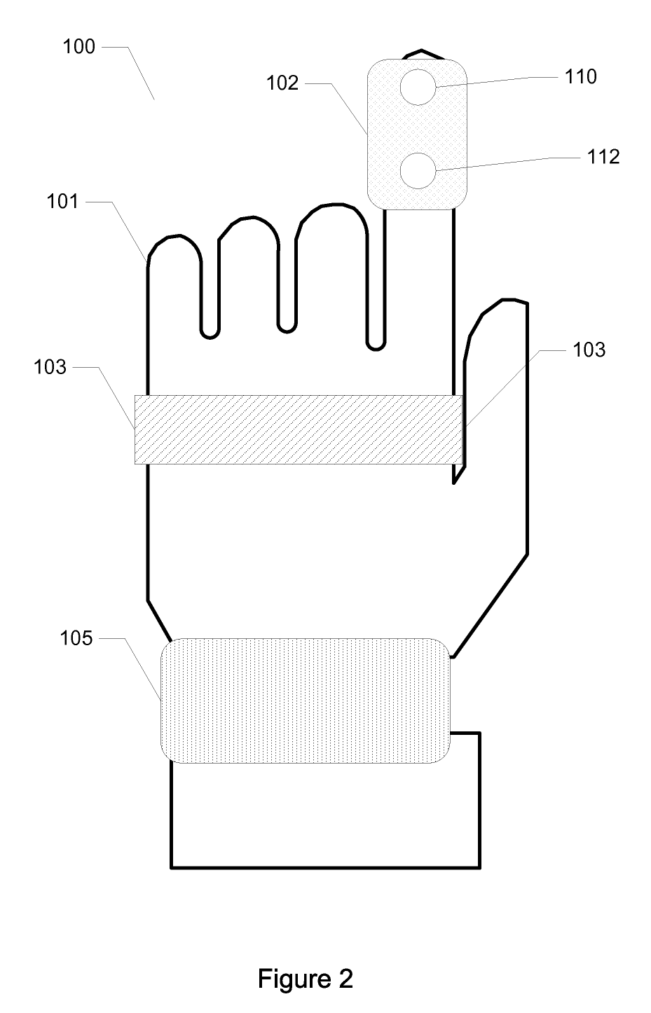

The input device 100 is shown attached to a user's hand from a top view, as seen from the back of a user's hand 101. FIG. 2 is a simplified diagram providing an alternative view of the input device 100. This diagram is merely an example, which should not unduly limit the scope of the claims. One of ordinary skill in the art would recognize many variations, alternatives, and modifications. For example, FIG. 2 shows the input device 100 as seen from the palm side of the hand 101.

Now referring back to FIG. 1. The input device 100 is secured to a user's hand 101 by the hand strap 103. Depending on the specific implementation, the hand strap may in various shapes and materials. In a specific embodiment, the hand strap 103 comprises an elastic band, which may be adjustable to fit a user's hand. The hand strap 103 may also come in different sizes. In another embodiment, the hand strap is ergonomically designed to conform to the shape of a user's hand, thereby allowing for good fit and comfort. The hand strap may be made in variety of materials. Synthetic materials such as nylon, plastic, spandex, and others may be used for making the hand strap.

Attaching to the hand strap 103 is the motion sensing module 104. The motion sensing module 104 is configured to capture various types of motion of the hand 101. In a specific embodiment, the sensing module 104 includes linear accelerometers and/or gyroscopes for capturing motion. For example, the sensing module 104 uses linear accelerometer to detect linear motion and uses gyroscopes to determine rotational movements. Depending on the application, various types of motion sensing devices may be used. In a specific embodiment, micro electro-mechanical systems (MEMS) type of accelerometers are used to detect linear motion. For example, multiple accelerometers may be used to capture three-dimension (3D) motion information along various directions (e.g., x, y, and z axes). It is to be appreciated that the motion capturing module 104 is configured to, among other things, determine motion information of the hand 101 in space. In a specific embodiment, the motion sensing module 104 is also configured to determine the position (e.g., facing up, down, etc.) of the hand 101 without movement.

It is to be appreciated that the motion information captured by the motion sensing module 104 can be used in many applications. In addition to gaming applications where the input device 100 is used as gaming controller, the motion sensing module 104, as an integral part of the input device 100, may also be used in other applications such as presentation, where a user can move presentation slides using the input device. There are many other applications as well.

The input device 100 is configured not only to capture motion information associated with the hand 101. The pointing module 102, another component of the input device 101, allows the input device 101 to have the functionality of a pointing device (e.g., mouse) as well. The pointing module 102, as shown in FIG. 1, is connected to the motion sensing module 104 through the wire 106, which provides both data and electricity pathway. As an alternative embodiment, the pointing module 102 may also be wirelessly connected to other components of the input device 100.

The pointing device 100, attached to a finger. Depending on the application, there can be additional pointing modules that are attached to different fingers of the same hand 101. In a specific embodiment, two pointing modules (not shown in the Figure) are separately attached to index finger and middle finger of the same hand.

It is to be appreciated that the input device 100 is designed to improve flexibility, convenience, and user experience. Accordingly, the pointing module 102 is designed to allow user to input data with convenience, according to an embodiment of the invention. For example, the pointing module 102 includes two or more laser source for to capture movement of the pointing module 102 against a surface. The surface does not need to be a flat surface where a mouse device is typically used on, but rather the surface may be any surface, such as clothing surface (e.g., a user can input finger motion on her cloth or other surface for the input device 100 to capture it).

According to an embodiment, the pointing module is configured to function in a similar way as a mouse device. For example, the user can use the pointing module 102 to select menu options provided by a graphical user interface. Similarly, in a gaming environment, the pointing module 102 can also be used to move a character and/or object in a computer game from one location to another. Having the advantage of being attached to finger, the pointing module 102 can have other functionalities that are not afforded by a conventional mouse device. In a specific embodiment, the pointing module 102 is used for text input, where a user can simply “write text” with her finger using the pointing module 102, and the writing motion is captured by the pointing module 102 and converted to text by software.

Depending on the application, the pointing module 102 can have other features as well. In an embodiment, the pointing module 102 includes a button 110, as shown in FIG. 2. For example, the button 110 is located on the tip side of the finger. When a user uses the pointing module 102 against a surface, the user can exert pressure on the pointing module 102, which results in the pressing of the button 110. For example, the button 110 may be configured to have the similar functionalities as mouse buttons. In a specific embodiment, the button 110 functions the same way as a left mouse button. In a specific embodiment, the button 110 includes a pressure sensor to determine whether the finger is in contact with a surface. For example, once it is detected that the button 110 is on a surface, a laser positioning sensor 112 starts capturing motion information. In various embodiments, the laser positioning sensor 112 is used as a mouse sensor.

The input device may have other buttons for receiving user inputs. As shown in FIG. 1, there is a button 108 located on the wrist component 105 of the input device. It is to be understood that FIG. 1 is a simplified diagram and that there may be additional buttons provided on input device, both on the write component and the motion sensing module 104. For example, a user is able to access one or more button using the other hand.

It is to be appreciated that the input device 100 is designed to improve user experience, through, among other features, flexibility and convenience. Depending on the application, the input device 100 may function in tether mode and/or wireless mode. For example, in the tethered mode, the input device 100 is connected to a computing device (e.g., computer, game console, etc.) through one or more wires, which allow both power and data transmission.

In an embodiment, the input device 100 is operates in a wireless mode. In the wireless mode, the input device 100 sends captured motion information, which can be from the pointing module 102 and/or the motion capturing module 104, to a computing device (and/or a game console) using a wireless transmitter. Depending on the application, the wireless transmitter may be located inside the module 104 and/or the component 105. The wireless transmitter can include an antenna for sending the captured motion information to an extended range. According to various embodiments, the wireless transmitter may use various types of wireless communication protocols, such as standard radio frequency signals, BLUETOOTH signals, and others.

In a specific embodiment, the captured motion information is processed by a processing module. For example, the processing module is configured to perform a variety of functions, such as converting captured motion information signals from one format to another. In an embodiment, the processing module converts the captured motion information signals a packets format for wireless transmission through the wireless transmitter. In another embodiment, the processing module is adapted to correlate and analyze captured motion information. For example, in an embodiment where two or more accelerometers are used for motion capturing, the processing module is configured to process and correlate motion information captured by the accelerometers.

As described above, the input device 100 is configured to capture motion information using the motion capturing module 104 and/or the pointing module 102. In an embodiment, the input device 100 includes a switch (not shown) that allows user to select an input mode, which includes mouse mode, three-dimensional (3D) mode, and two-dimensional (2D) mode. For example, in the mouse mode, the pointing module 102 is exclusively used for capturing motion of the finger in relation to a surface, and the functionality of the pointing module 102 resembles a mouse device. In the 3D and 2D modes, the motion capturing module 104 is used for motion information capture. For example, in the 3D mode, the motion capturing module 104 captures motion information from the hand movement in space relative to a predetermined point of reference. By way of an example, in the 2D mode, the motion capturing module 104 captures motion information from the hand movement in relation to a virtual surface (e.g., computer screen).

In a specific embodiment, the input device 100 also includes security module (not shown in FIGS. 1 and 2) as it is built in. The security module is configured to generate a first security code based on a user's identification based on a specific scheme (e.g., time of the day, etc.), which is used to compare with a second security code generated by a remote computer. If the first security code and the second security code are determined to be matching in accordance to the specific scheme, then the user is allowed to log onto the system. It is to be appreciated that in this manner, a user is able to log onto a remote system that is connected to the input device 100 automatically without having to type in user names and passwords.

FIGS. 1 and 2 merely provides a simplified diagram of the input device 100 from the outside. Various components of the input device 100, either shown or not shown in

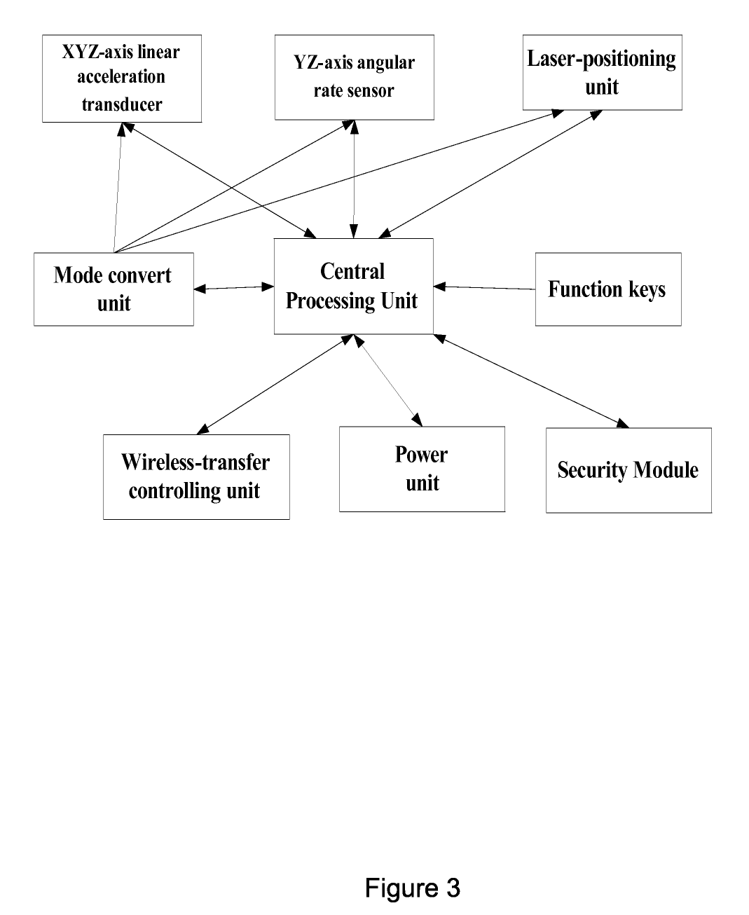

FIGS. 1 and 2, are connected to one another to provide the functionalities provided above. FIG. 3 is a simplified block diagram illustrating component modules of a input device according to an embodiment of the present invention. This diagram is merely an example, which should not unduly limit the scope of the claims. One of ordinary skill in the art would recognize many variations, alternatives, and modifications.

It is to be appreciated that FIGS. 1 and 2 illustrated an input device that is attached to a single hand. Depending on the application, two or more input devices may be used by a single user. In a specific embodiment, a user wears input devices on both hands, and each of the input devices are configured for motion capturing. For example, a software module is used to correlate motion information from input devices from both left and right hands of the same user.

As shown in FIG. 3, various accelerometer modules for various axes are used to capture motion information, which is processed by the central processing unit. The central processing unit is also configured to operate the laser-positioning unit, which functions in a mouse mode. The central processing module also determines which mode (mouse mode, 2D mode, and 3D mode) the input device operates.

In Addition to the motion capture, the input device in FIG. 3 is also configured to receive user inputs by ways of traditional button and/or functions keys. In FIG. 3, function keys are connected to the central processing unit.

Also connected to the central processing unit is a security module. As described above, the security module facilitates user log in by providing security. In a specific embodiment, the security module is configured to generate rolling security code based on a predetermine scheme that is shared by a remote device.

As shown, the central processing module is connected to a mode convert unit. The wireless transfer control unit is used for communication with a remote device (e.g., a computing device). For example, captured motion information is processed by the central processing unit and then transmitted through the wireless controlling unit.

The input device as shown in FIG. 3 has a power unit that is connected to the central processing unit. The power unit is used to provide necessary energy for operating the input device. Depending on the application, the power unit may also be electrically coupled to other components of the input device. For example, the power unit includes a rechargeable battery for power supply.

According to an embodiment, an input apparatus is provided. The apparatus includes a connection portion which connects the apparatus and the user's hands with wires. The apparatus has a shape of a hollowed-out glove includes a hollowed-out back part of hand and finger caps part. Remote control keys are located on the area except the back and the finger's cap of the hollow-out glove. The wrist of the hollowed-out glove also includes other necessary parts of the remote control such as battery storage for holding the power supply. The back part of the glove contacts with the user's hand adequately, humanized design ensures this apparatus comfortably dressed on the user's hand. The connection portion further includes wires which connect finger caps and the back of glove. Length of the linking wires should be adjusted, which enables the apparatus can be worn by users whose hands vary in size.

The finger caps include an index finger cap, which can be removed from the finger. When removed, this finger cap could be coupled on other device. For example, user can write on the surface using a pen instead of his index finger, there the finger cap is attached to the pen instead of a finger.

The apparatus includes laser-positioning device, which is designed on the said index finger cap. When the apparatus is set in the touch mode, laser-position device becomes active. When the user's finger moves, the laser-positioning device will move with it. A touch point is set at the end of the finger cap, when the touch point contacts with a flat surface, it works as left key of a mouse device. The reflecting surface may be of any material which has reflective properties, such as clothes, a hand, a desk (except transparent glass surfaces), a book or the armrest of a sofa. When the touch point contacts with the reflecting surface, the touch point is active to track the pen's writing on any reflecting surface. In this mode, just like the left key of a mouse device is hold down. User can move his fingers as writing on the a surface, the receiver which is set in the end of the terminal identifies the laser signals transmitted via RF (radio frequency) to the terminal, such as a personal computer. So the apparatus can control user's moving motion successfully. When the device is moving away from the flat surface (but not too far), the laser is still working and the user still can write on the space with no tracking mark. User also can take the finger cap away from index finger and dress it on a pen to use it as a touch pen.

The finger caps of the connecting portion further include a finger cap for the middle finger. When the key on the middle finger cap is contacting with the surface, it works as the right key of a mouse device. The connection portion may also include other fingers caps according to the requirements of a user.

There is a key set on the side of the index finger cap opposite to the pollex thumb finger. When the apparatus is in the air-mouse mode, it works as the left key of a mouse device. Another key is set on the finger cap of the middle finger; when the apparatus is in the air-mouse mode, it works as the right key of a mouse device.

On the wrist of the hollowed-out glove, there is a wheel key, which works as a mouse device wheel. The user can use it to turn pages up and down to browse information rapidly and conveniently.

Besides the above function modules, this apparatus further includes an XYZ-axis (i.e., three dimensional) linear acceleration sensor on the back of the glove and a YZ-axis angular rate sensor on the wrist of the glove. These two kinds of sensors can capture user's moving motion in the multi-dimension space when the apparatus is working in air-mouse mode and action-induction mode.

The above sensor, laser-positioning device and keys should be set on the right hand glove or the left hand glove according to requirements of a user.

With above structure, this apparatus has three application modes:

When it was set in touch mode, the laser-positioning part is active. User can move his hand which wearing this apparatus on the flat surface. A laser-positioning device is located on the surface of index finger cap. When user writes words on the flat surface with his index finger, the laser-positioning devices can track his moving motion and send the motion signals to the receiver via RF. This working mode needs the apparatus moving on the flat surface or the position not far from the flat surface. When user press the touch point which located at the end of the index finger cap, the touch point works as the left key of a mouse device.

This laser-positioning unit is designed in ordinary optical-mouse principle. The optics and electrics units are all located on the index finger cap, according to the finger's moving motion, the final motion controlling signals will be transferred to the terminals (for example, computer device) via wireless-transferring unit via RF or Bluetooth. So wearing this apparatus on the hand, user can finish his motion controlling in touch mode.

In this mode, user can take off the index finger cap from his finger and dress it on other device, for example, a pen. So he can use this pen to write words on the surface instead of his fingers. The wire which connecting the finger cap with the hollow-out glove should be adjusted, so the glove can be dressed on various user's hand.

When user pressed the select key and entered into air-mouse mode, transducers become active, user can move his hands discretionarily in the space. Transducer set on the back of the apparatus is designed with XYZ-axis linear acceleration sensor, and on the wrist of the apparatus, there is an YZ-axis angular rate loop sensor. Working with all the transducers, the apparatus can identify user's moving motions in any directions accurately. In this mode, it works like a 3D mid-air mouse.

A key set on the side of the index finger cap acts as the left key of a mouse device. If necessary, user could add a middle finger cap, another key set on the side of the middle finger cap acts as the right key of a mouse device. For example, when user plays cards with this apparatus, he moves his hand to select a card, press the key on his index finger cap with his thumb to select the desired card, and then release his thumb to lay down this card, so he can play card game successfully.

In this mode, the YZ-axis angular rate loop sensor can capture the user's moving angle displacement, and then transfer these moving data to the control terminal, so user can identify the direction and location on the terminal monitor. When the apparatus is in this mode, the XYZ-axis linear acceleration sensor will correct the tracking jitters which were made when the user moves his hand, and reduce the errors to ensure the accuracy of moving motion.

In the air-mouse mode, we can add another hand glove according to our operating circumstance. For example, user plays tennis game that needs two hands to operate with. Another glove should be designed with only XYZ-axis linear acceleration sensor. On the said index finger cap, there should be an additional rocker key, so user can control the directions with it conveniently. The user's moving motion could be captured by sensor and be sent to the receiver via RF or Bluetooth.

When the apparatus is set in action-induction mode, the XYZ-axis linear acceleration sensor will capture the user's moving direction and displacement, and then send the moving data to the control terminal. The terminal device can get the user's linear displacement by analyzing the moving data. The YZ-axis angular rate loop sensor will capture the user's moving angle displacement and send data to the control terminal. User's moving motion in all directions will be identified by the two transducers. In this mode, the data transferred between the apparatus and the terminal is RF or Bluetooth.

The apparatus mentioned in this invention may have multiple extended structures, not merely limited to the above said. For example, keys are set not only on the index finger and the middle finger; the finger cap may be removed and dressed on a pen suitable in size to service as a pen-shaped product. The index finger cap can be designed in the head of a pistol, so it can become a pistol-shaped product. Similarly, the finger cap may be designed in other wheel-shaped like a steering wheel or a controlling stick, a bat, a baseball bat, a fishing rod, a golf club, a doll, a bicycle or a skateboard.

This apparatus provided in this invention is not limited to the interaction between user and computer. The apparatus may replace the laptop mouse in the touch mode or in the air-mouse mode. In air-mouse mode, the apparatus works as an air-mouse device, in the touch mode, the apparatus could replace the laptop's mouse to finish the operation in any flat surface.

User can play games with the apparatus, for example, playing cards in air-mouse mode. When playing mahjong game, user moves his fingers on the displayed game interface, pausing on the desired card, then “picks up” this card with his thumb and index finger, releases the fingers to lay down the card, so this card will be finished. User can also play games like “Cooking Mamma” with the apparatus, user choose the menu item and working mode, in this procedure, he can set the apparatus in touch mode. When user begins to cook, he can set the apparatus in remote control mode or air-mouse mode.

When user intends to search for music with this apparatus via a computer, he can write down name of the desired song, e.g. “the winter” (song's name) in touch mode, and then set this apparatus in remote controlling mode, press the “OK” key, the song will be displayed on the computer for him to download. With this apparatus, user can also draw in touch mode.

The apparatus provided in this invention makes moving motion controlling in multi-dimension space to be reality. Converting among three modes, the apparatus can finish operation in various surfaces and space, especially used in playing video game, this apparatus takes the player far away from the desk and mouse device and keyboard device, he can move himself to wherever and play video games freely.

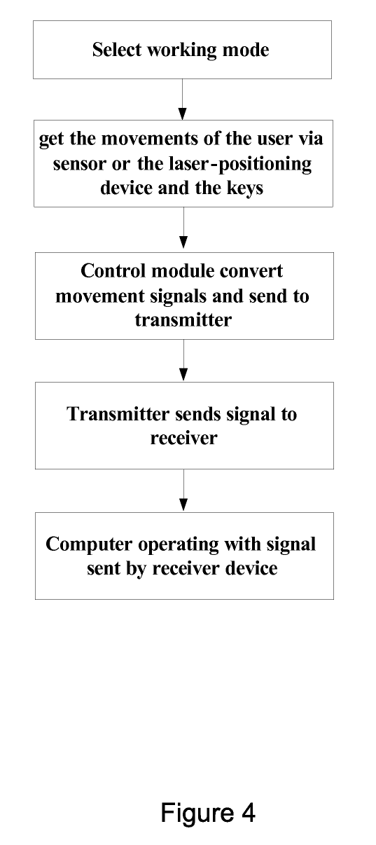

FIG. 4 is a simplified flow diagram illustrating a method for using an input device according to an embodiment of the present invention. This diagram is merely an example, which should not unduly limit the scope of the claims. One of ordinary skill in the art would recognize many variations, alternatives, and modifications. For example, various steps as shown in FIG. 4 can be added, removed, repeated, replaced, modified, and/or overlapped, and should not limited the scope of the present invention.

A method, as shown in FIG. 4, for operating an input device (e.g., input device 100 in FIG. 1), includes following steps:

Step 1, select working mode;

Step 2, get the user's moving motion via the sensor or the laser-positioning device or the keys;

Step 3, control module converts the user's motion signal which captured by the sensor or the laser-position device into a transmitter-readable signal, then sends it to the transmitter;

Step 4, transmitter sends the signal to the receiver;

Step 5, receiver sends the signal to the terminal device, the terminal run the program with the received signals.

According to an embodiment of the present invention, the present invention provides an user interface device. The device includes a housing member, the housing member including a first portion, the first portion being conforming to human hand. The device also includes a battery, the battery being positioned inside the housing member. Furthermore, the device includes a control module, the control module being electrically coupled to the battery, the control module being configured to select input modes. The device also includes a laser pointing module, the laser point module being adapted for attaching to one or more of fingers, the laser pointing module being configured to capture finger movements from the one or more fingers in relation to a surface. Additionally, the device includes an accelerometer module being adapted to be attached a user hand, the accelerometer module being configured to capture the hand movement. The device also includes one or more keys being adapted to receive user input. The device further includes a wireless transmitter. The control module is configured to determine an input mode, process finger movements and/or hand movements based at least on input mode, generate one or more signals based on the finger movements and/or hand movements, and transmit the one or more signals.

According to another embodiment, the present invention provides an user interface device, which includes a battery module configured to provide power. The device also includes a connection housing adapted for attaching the device to a user's hands with wires. The device further includes a switch key configured to determine an operation mode, operation mode being selected from a touch mode, an air-mouse mode, and an action-induction mode. Moreover, the device includes a laser-positioning device being attachable to one or more fingers, the laser positioning device being configured to capture motion information relative to a surface in the touch mode. The device includes one or more accelerometer devices for capturing motion information in the air-mouse mode and the action-induction mode. The device also includes a control module being configured for processing the captured motion information. Also, the device includes a transmitter for sending processed motion information. The device further includes a touch point for receiving user inputs, the touch point being adaptable for functioning as a left mouse key. Additionally, the device includes one or more control keys for receiver user inputs, the one or more control keys being configured to function as programmable mouse keys.

According to yet another embodiment, the present invention provides a method for operating a user interface device. The method includes providing the user interface device, the user interface device comprising a laser point module, an accelerometer module, a wireless transmitter, and a mode selection module. The method also includes determining an input mode based on a status indicated by the mode selection module. If the input mode is in a mouse mode, the method includes capturing movement information using the laser pointing module, processing the captured movement information, and transmitting the processed movement information using the wireless transmitter. If the input mode is in a free mode, the method includes capturing movement information using the accelerometer module, processing the captured movement information, and transmitting the processed movement information using the wireless transmitter.

It is also understood that the examples and embodiments described herein are for illustration purposes only. Various modifications or changes in light thereof will be suggested to persons skilled in the art and are to be included within the spirit and purview of this application and the scope of the appended claims.

What is claimed is:

1. An user interface device comprising:
a housing member, the housing member including a first portion, the first portion being conforming to human hand;
a battery, the battery being positioned inside the housing member;
a control module, the control module being electrically coupled to the battery, the control module being configured to select input modes;
a laser pointing module, the laser point module being adapted for attaching to one or more of fingers, the laser pointing module being configured to capture finger movements from the one or more fingers in relation to a surface;
an accelerometer module being adapted to be attached a user hand, the accelerometer module being configured to capture the hand movement;
one or more keys being adapted to receive user input;
a wireless transmitter;
wherein the control module is configured to:
determine an input mode;
process finger movements and/or hand movements based at least on input mode;
generate one or more signals based on the finger movements and/or hand movements;
transmit the one or more signals.

2. The device of claim 1 further comprising a strapping member for attaching the housing member to the user hand.

3. The device of claim 2 wherein the strapping member is adapted to couple the housing member to a palm and/or wrist of the user hand.

4. The device of claim 1 further comprising pairing member, the pairing member being configured to capture motion information from a different user hand.

5. The device of claim 4 wherein the pairing member is wirelessly connected to the control module.

6. The device of claim 1 wherein the input mode is selected from a mouse mode, a 2D mode, and a 3D mode.

7. The device of claim 1 wherein the finger movements are used to calculate a movement in relation to a surface if the input mode is a mouse mode. of gyroscopes.

8. The device of claim 1 wherein the accelerometer comprises a plurality

9. The device of claim 1 where the accelerometer module comprises a x-direction gyroscope, a y-direction gyroscope, and a z-direction gyroscope.

10. The device of claim 1 wherein the hand movements are used to calculate a three-dimensional spatial movement in relation to one or more predetermine locations if the input mode is a three-dimensional mode.

11. The device of claim 1 wherein the wireless transmitter is configured to pair with a USB connector, the USB connector being adapted for attaching to a computing device.

12. The device of claim 1 where the one or more keys are positioned in a wrist portion of the housing member.

13. The device of claim 1 where the one or more keys are user programmable.

14. The device of claim 1 wherein the wireless transmitter comprises a radio frequency transmitter.

15. The device of claim 1 wherein the wireless transmitter comprises a blue tooth transmitter.

16. The device of claim 1 wherein the accelerometer module is configured to detect linear and/or angular motion.

17. The device of claim 1 wherein the accelerometer module is configured to detect hand movement in a three-dimensional mode.

18 . The device of claim 1 wherein the accelerometer module is configured to detect hand movement in a two-dimensional mode

19. The device of claim 1 wherein the housing member conforms to a shape associated with a backside of the user hand.

20. The device of claim 1 wherein the battery is rechargeable.

21. The device of claim 1 wherein the battery is removable.

22. The device of claim 1 where the laser pointing module comprises two or more laser lights.

23. The device of claim 1 where in the housing member comprises plastic material.

24. The device of claim 1 where in the housing member comprises nylon material.

25. The device of claim 1 wherein the accelerometer comprises a micro electro-mechanical systems (MEMS) device.

26. The device of claim 1 wherein the accelerometer comprises a gyroscope.

27. An user interface device comprising:
a battery module configured to provide power;
a connection housing adapted for attaching the device to a user's hands with wires;
a switch key configured to determine an operation mode, operation mode being selected from a touch mode, an air-mouse mode, and an action-induction mode;
a laser-positioning device being attachable to one or more fingers, the laser positioning device being configured to capture motion information relative to a surface in the touch mode;
one or more accelerometer devices for capturing motion information in the air-mouse mode and the action-induction mode;
a control module being configured for processing the captured motion information;
a transmitter for sending processed motion information;
a touch point for receiving user inputs, the touch point being adaptable for functioning as a left mouse key;
one or more control keys for receiver user inputs, the one or more control keys being configured to function as programmable mouse keys.

28. The device of claim 27 wherein further comprising a remote control.

29. The device of claim 27 wherein the laser-positioning device comprises two or more laser lights.

30. The device of claim 27 wherein the connection housing includes a first housing and a second housing, the first housing being attachable to a first user hand, and second housing being attachable to a second user hand.

31. The device of claim 27 wherein the control module is associated with a software interface.

32. The device of claim 27 further comprising a security module, the security module being configured to generate a first security code based on a predetermined scheme, the first security code compared to a second security code based on the predetermined scheme.

33. A method for operating a user interface device, the method comprising:
providing the user interface device, the user interface device comprising a laser point module, an accelerometer module, a wireless transmitter, and a mode selection module;
determining an input mode based on a status indicated by the mode selection module;
if the input mode is in a mouse mode:
capturing movement information using the laser pointing module;
processing the captured movement information;
transmitting the processed movement information using the wireless transmitter;
if the input mode is in a free mode:
capturing movement information using the accelerometer module;
processing the captured movement information;
transmitting the processed movement information using the wireless transmitter.

34. The method of claim 33 further comprising an air mouse mode, wherein:
if the input mode is in the air mouse mode:
capturing movement information using the laser pointing module, the movement information relating to a surface plane;
processing the captured movement information;
transmitting the processed movement information using the wireless transmitter.

35. The method of claim 33 further comprising receiving a user mode selection.

36. The method of claim 33 further comprising detecting a user movement.

37. The method of claim 33 further comprising determining a relative two-dimensional movement based on a three-dimensional movement information.

38 . The method of claim 33 further comprising capturing angular and linear movement.
